(19) United States
(12) Patent Application Publication
(10) Pub. No.: US 2005/0099712 A1
(43) Pub. Date: May 12, 2005

(54) Color wheel and color filter assembly thereof

(76) Inventors: Po-Sung Kao, Taichung (TW); Shou-Chy Chia, Taichung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/790,924

(22) Filed: Mar. 1, 2004

(30) Foreign Application Priority Data
Nov. 11, 2003 (TW) 92131510

(51) Int. Cl. G02B 5/22; H04N 9/78; G02B 7/00

(52) U.S. Cl. 359/892; 359/891

(57) ABSTRACT

A color filter assembly. The color filter assembly rotates around a central axis thereof and includes a carrier, a color filter and a plurality of balancing elements. The carrier rotates around the central axis and has a plurality of holes. The color filter is fixed to the carrier and the balancing elements are movably and individually disposed in the holes such that the center of mass of the color filter assembly is on the central axis.

### BACKGROUND OF THE INVENTION

1. Field of the Invention

The present invention relates in general to a color wheel and in particular to a color filter assembly thereof providing improved balance and stability of rotation.

2. Description of the Related Art

Referring to FIGS. 1a and 1b, the conventional color wheel comprises a carrier 11, a color filter 12 and a motor 2. The color filter 12 is fixed to the carrier 11 by adhesive 13, wherein the carrier 11 and the shaft 22 are connected and secured at the center of the motor 2 with the cover 21. The motor 2 rotates the carrier 11 and the color filter 12 around central axis 10 via the shaft 22.

As shown in FIG. 1b, conventional color filter 12 has three filter segments 12a, 12b and 12c. A recess 18 is formed on the carrier 11 to compensate unbalanced mass thereby providing stable rotation. It is difficult to precisely form the recess 18 however, and unbalanced mass distribution may occur, for example, due to flow of adhesive 13. Hence, stability and balanced rotation is difficult to achieve in the conventional color wheel.

### SUMMARY OF THE INVENTION

Accordingly, an object of the present invention is to provide a color filter assembly. The color filter assembly rotates around a central axis thereof and includes a carrier, a color filter and a plurality of balancing elements. The carrier rotates around the central axis and has a plurality of holes. The color filter is fixed to the carrier and the balancing elements are movably and individually disposed in the holes such that the center of mass of the color filter assembly is on the central axis.

### DESCRIPTION OF THE DRAWINGS

The present invention will become more fully understood from the detailed description given hereinbelow and the accompanying drawings, given by way of illustration only and thus not intended to be limitative of the present invention.

FIGS. 1a and 1b are perspective diagrams of a conventional color wheel.

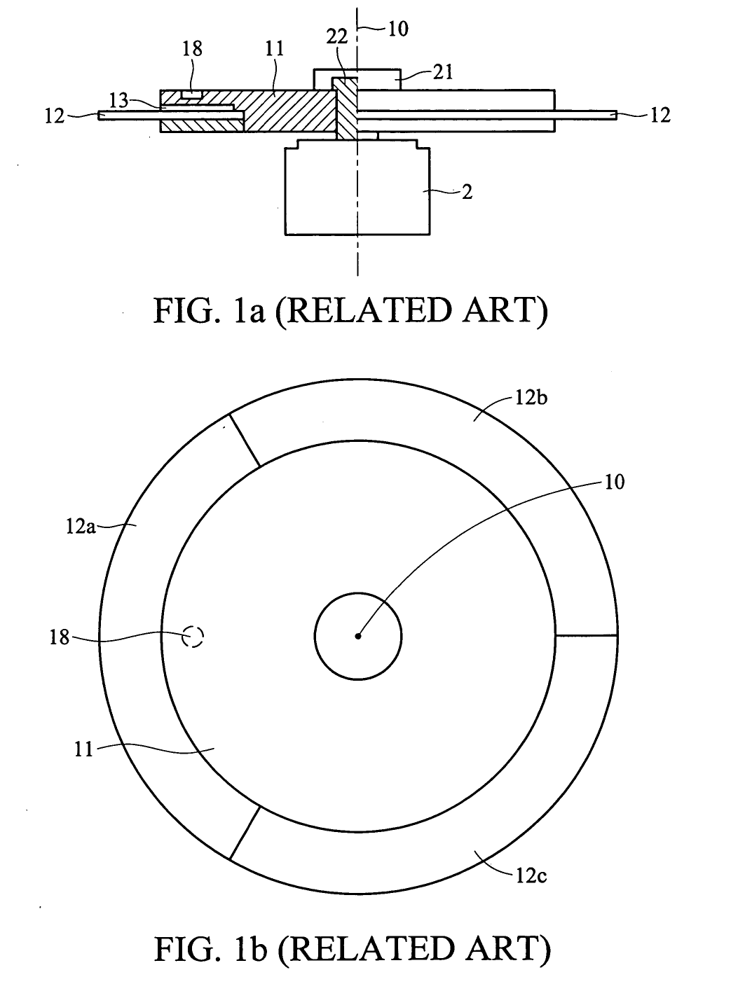

FIGS. 2 and 3 are perspective diagrams of the first embodiment of the present invention.

FIG. 4 is a perspective diagram of the second embodiment of the present invention.

### DETAILED DESCRIPTION OF THE INVENTION

### First Embodiment

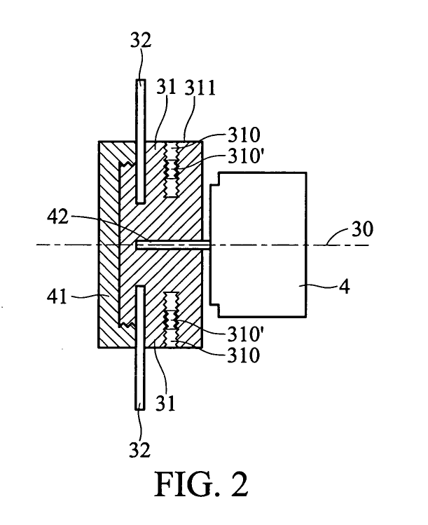

Referring to FIG. 2, the color wheel includes a color filter assembly having a carrier 31 and a color filter 32 fixed thereto. The motor 4 and the carrier 31 are connected with the shaft 42 at the center thereof. The motor 4 rotates the carrier 31 and the color filter 32 around central axis 300 via the shaft 42. The carrier 31 and the color filter 32 are firmly connected by the securing member 41 which is fastened to the carrier 31 and abuts the color filter 32. As shown in FIG. 2, the carrier 31 has a plurality of holes 310 disposed on the lateral surface. The holes 310 are parallel to the surface of color filter 32 and extend longitudinally toward the central axis 30. A plurality of balancing elements 310′ are movably disposed in the holes 310 and adjusted such that the center of mass of the color filter assembly locates on the central axis 30 for improving rotational stability.

Referring to FIG. 3, the balancing elements 310′ movably disposed in the four holes 310 are evenly arranged on the circular peripheral surface of carrier 31. Moreover, the holes 310 extend longitudinally toward and are symmetrical to the central axis 30. In FIG. 3, the color filter 32 comprises four filter segments 32a, 32b, 32c and 32d, however, the filter segments can also be integrally formed. To balance mass, each balancing element 310′ can be adjusted and appropriately positioned in the hole 310 such that the center of mass of the color filter assembly locates on the central axis 30. If the center of mass locates at the left side with respect to the central axis 30, the balancing element 310′ in the left hole 310 can be moved rightward (inward) such that the center of mass locates on the central axis 30 to improve stability and balance of rotation. Similarly, the balancing elements 310′ in the upper and lower holes 310 can also be adjusted and appropriately positioned if the center of mass is at the upper or lower side. After appropriate positioning and adjustment, the balancing elements 310′ are adhered to the carrier 31.

As shown in FIGS. 2 and 3, the balancing elements 310′ and the holes 310 are correspondingly threaded such that the balancing elements 310′ can be moved inward or outward easily for precise positioning in the holes 310. Thus, the present invention achieves balanced mass through precise calibrating, and stability of rotation is improved thereby.

### Second Embodiment

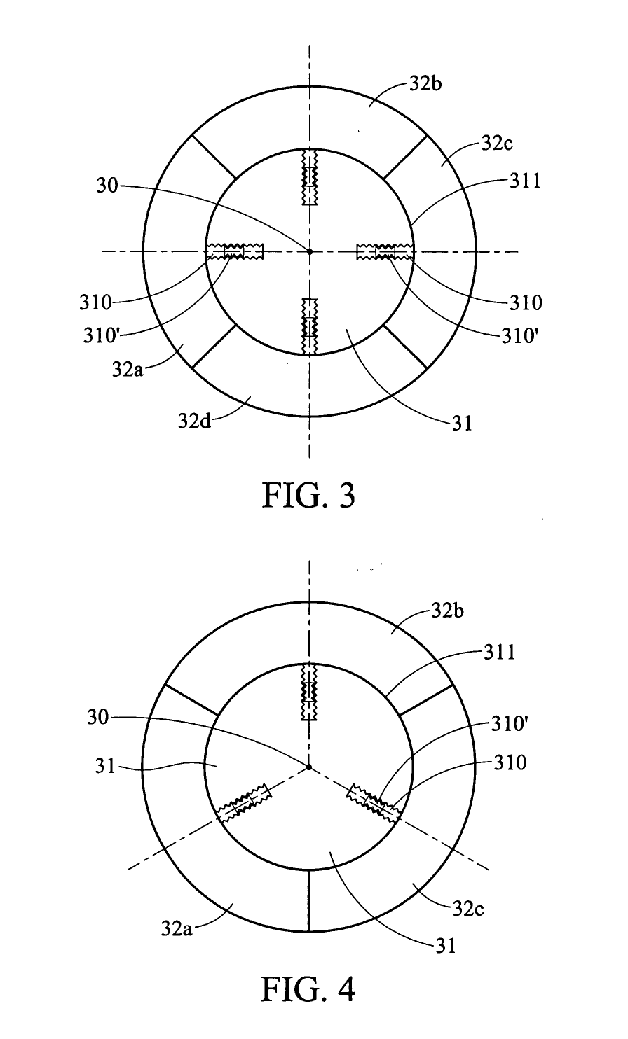

As mentioned, according to the present invention, a plurality of balancing elements 310′ are provided to compensate unbalanced mass. Referring to FIG. 4, the carrier 31 has three holes 310 evenly arranged on the circular peripheral surface. The holes 310 extend longitudinally toward and are symmetrical to the central axis 30. Therefore, the balancing elements 310′ can be adjusted and appropriately positioned in the holes 310 such that the center of mass of the color filter assembly locates on the central axis 30 to improve stability of rotation.

In summary, the color wheel and the color filter assembly thereof in the present invention can be applied to an optical device such as a DLP projector. A plurality of adjustable balancing elements 310′ and corresponding holes 310 of the carrier 31 are provided such that the center of mass of the color filter assembly is maintained on the central axis 30. The present invention has a simple structure, is easy to calibrate, and as such improves rotational stability.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

1. A color filter assembly rotating around a central axis thereof, including:
a carrier having a plurality of holes and rotating around the central axis;
a color filter fixed to the carrier;
a plurality of balancing elements individually and movably located in the holes such that the center of mass of the color filter assembly is on the central axis.

2. The color filter assembly as claimed in claim 1, wherein the holes are formed parallel to the color filter and longitudinally toward the central axis.

3. The color filter assembly as claimed in claim 1, wherein the holes are symmetric to the central axis.

4. The color filter assembly as claimed in claim 1, wherein the holes are threaded for the balancing elements moving therein.

5. The color filter assembly as claimed in claim 1, wherein the balancing elements are adhered to the carrier when the center of mass of the filter assembly is on the central axis.

6. A color wheel, including:
a filter assembly of claim 1;
a motor;
a shaft at the central axis connecting the motor and the filter assembly, wherein the motor rotates the filter assembly via the shaft;

7. The color filter assembly as claimed in claim 6, wherein the holes are formed parallel to the color filter and longitudinally toward the central axis.

8. The color filter assembly as claimed in claim 6, wherein the holes are symmetric to the central axis.

9. The color filter assembly as claimed in claim 6, wherein the holes are threaded for the balancing elements moving therein.

10. The color filter assembly as claimed in claim 6, wherein the balancing elements are adhered to the carrier when the center of mass of the filter assembly is on the central axis.
